(19) United States
(12) Patent Application Publication
(10) Pub. No.: US 2012/0327558 A1
(43) Pub. Date: Dec. 27, 2012

(54) CONDUCTIVE PASTE COMPOSITION FOR INTERNAL ELECTRODE AND MULTILAYER CERAMIC CAPACITOR INCLUDING THE SAME

(75) Inventors: Hyun Chul Jeong, Suwon (KR); Young Ho Kim, Suwon (KR); Jong Han Kim, Suwon (KR)

(73) Assignee: SAMSUNG ELECTRO-MECHANICS CO., LTD.

(21) Appl. No.: 13/528,163

(22) Filed: Jun. 20, 2012

(30) Foreign Application Priority Data
Jun. 23, 2011 (KR) 10-2011-0061234

(51) Int. Cl. H01G 4/12; B82Y 30/00

(52) U.S. Cl. 361/321.4; 977/788

(57) ABSTRACT

A conductive paste composition for an internal electrode, and a multilayer ceramic capacitor (MLCC) including the same are provided. The conductive paste composition for an internal electrode includes: 100 parts by weight of metal powder particles; and 0.1 to 10 parts by weight of carbon nano-tubes (CNTs). The conductive paste composition for an internal electrode may control sintering shrinkage of metal powder particles.

### CROSS-REFERENCE TO RELATED APPLICATIONS

This application claims the priority of Korean Patent Application No. 10-2011-0061234 filed on Jun. 23, 2011, in the Korean Intellectual Property Office, the disclosure of which is incorporated herein by reference.

### BACKGROUND OF THE INVENTION

1. Field of the Invention

The present invention relates to a conductive paste composition for an internal electrode and a multilayer ceramic capacitor and, more particularly, to a conductive paste composition for an internal electrode in which sintering shrinkage of metal powder particles is controlled, and a multilayer ceramic capacitor including the same.

2. Description of the Related Art

In general, an electronic component using a ceramic material such as a capacitor, an inductor, a piezoelectric element, a varistor, a thermistor, or the like, includes a ceramic element made of a ceramic material, internal electrodes formed within the ceramic element, and external electrodes installed on surfaces of the ceramic element such that they are connected to the internal electrodes.

Between and among ceramic electronic components, a multilayer ceramic capacitor (MLCC) includes a plurality of laminated dielectric layers, internal electrodes disposed to face each other with a dielectric layer interposed therebetween, and external electrodes electrically connected to the internal electrodes.

A MLCC is commonly used as a component of mobile communications devices such as portable computers, personal digital assistants (PDAs), mobile phones, and the like, due to advantages such as compactness, guaranteed high capacity, and ease of mountability.

Recently, as the trend has been for electronic products to have high performance and reductions in weight, thickness, length, and size, electronic components have been required to be smaller, have high performance, and be reduced in costs. In particular, the development of CPUs having high speeds and devices in which multi-functionalization has been realized and which are smaller and lighter as well as digitalized has prompted research and development aiming at implementing a multilayer ceramic capacitor (MLCC) which is small, includes thinner layers, has high capacity, and has low impedance at a high frequency, and the like.

An MLCC may be fabricated by laminating a conductive paste for an internal electrode and ceramic green sheets through a sheet method, a printing method, or the like, and simultaneously firing the same. However, in order to form a dielectric layer, the ceramic green sheet may be fired at a high temperature of 1100 L or higher, and the conductive paste may be sintered to thereby be shrunk at a relatively low temperature. Thus, while the ceramic green sheet is being fired, internal electrodes may be excessively fired, and begin to be agglomerated or be broken, and connectivity of the internal electrodes may be degraded. Also, an internal structure of the MLCC may have a defect such as cracking, or the like, after the firing operation.

### SUMMARY OF THE INVENTION

An aspect of the present invention provides a conductive paste composition for an internal electrode in which sintering shrinkage of metal powder particles is controlled, and a multilayer ceramic capacitor including the same.

According to an aspect of the present invention, there is provided a conductive paste composition for an internal electrode of a multilayer ceramic capacitor (MLCC), including: 100 parts by weight of metal powder particles; and 0.1 to 10 parts by weight of carbon nano-tubes (CNTs).

The metal power particles may be formed of one or more selected from the group consisting of nickel (Ni), manganese (Mn), chromium (Cr), cobalt (Co), aluminum (Al), and alloys thereof.

The length of CNTs may be 100 nm or less.

The CNTs may be dispersed by ultrasonic waves and mixed with the metal powder particles.

According to another aspect of the present invention, there is provided a multilayer ceramic capacitor (MLCC) including: a ceramic element; and internal electrodes formed within the ceramic element and including carbon nano-tubes (CNTs).

The internal electrodes may include 100 parts by weight of metal powder particles and 0.1 to 10 parts by weight of CNTs.

The CNTs may be dispersed by ultrasonic waves and mixed with the metal powder particles.

The metal power particles may be formed of one or more selected from the group consisting of nickel (Ni), manganese (Mn), chromium (Cr), cobalt (Co), aluminum (Al), and alloys thereof.

The length of CNTs may be 100 nm or less.

The ceramic element and the internal electrodes may be formed through simultaneous firing.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a multilayer ceramic capacitor (MLCC) according to an embodiment of the present invention;

FIG. 2 is a schematic cross-sectional view of the MLCC taken along line A-A′ in FIG. 1;

FIG. 3 is a schematic view showing a conductive paste composition for an internal electrode according to an embodiment of the present invention;

FIGS. 4A and 4B are schematic views showing sintering shrinkage behavior of the conductive paste for an internal electrode according to an embodiment of the present invention;

FIG. 5 is a graph showing the sintering shrinkage behavior of the conductive paste composition according to an embodiment of the present invention; and

FIGS. 6 through 8 are scanning electron microscope (SEM) photographs obtained by capturing images of surfaces of internal electrodes formed according to comparative examples and an embodiment of the present invention, respectively.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

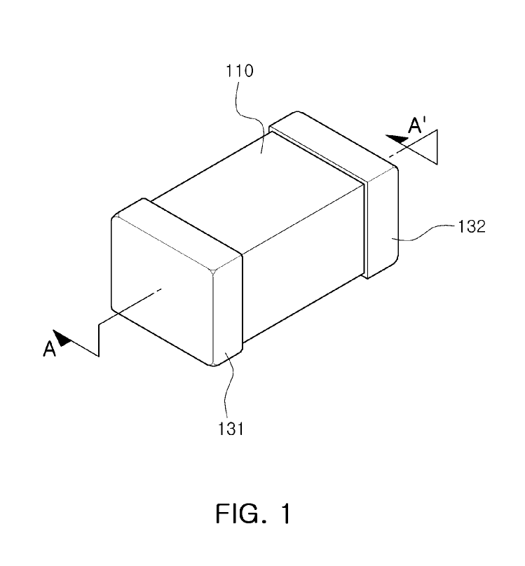

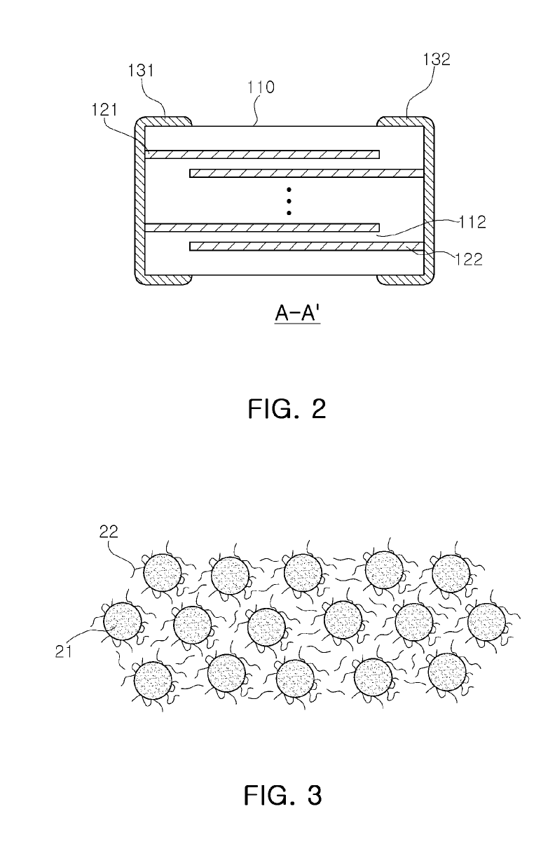

FIG. 1 is a schematic perspective view of a multilayer ceramic capacitor (MLCC) according to an embodiment of the present invention, and FIG. 2 is a schematic cross-sectional view of the MLCC taken along line A-A′ in FIG. 1.

With reference to FIGS. 1 and 2, the MLCC according to an embodiment of the present invention may include a ceramic element 110, internal electrodes 121 and 122 formed within the ceramic element 110, and eternal electrodes 131 and 132 formed on an outer surface of the ceramic element 110.

The ceramic element 110 may generally have a rectangular parallelepiped shape, but there is no particular limitation on the shape of the ceramic element 110. Also dimensions of the ceramic element 110 are not particularly limited, but for example, the MLCC may have a size of, for example, 0.6 mm×0.3 mm and have a high laminated layers and high capacity of 22.5 μF or more.

The ceramic element 110 may be formed by laminating a plurality of dielectric layers 111. The plurality of dielectric layers 111 constituting the ceramic element 110 are in a sintered state and adjacent dielectric layers 111 are integrated such that boundary therebetween may not be readily apparent.

The dielectric layers 111 may be formed by sintering ceramic green sheets including ceramic powder particles.

Ceramic powder particles generally used in the art may be used as the ceramic powder particles according to the present embodiment, without being particularly limited. For example, BaTiO₃-based ceramic powder particles may be used, but the present invention is not limited thereto. The BaTiO₃-based ceramic powder particles may include (Ba₁₋ₓCaₓ)TiO₃, Ba(Ti_{1-y}Ca_{y})O₃, (Ba₁₋ₓCaₓ) (Ti_{1-y}Zr_{y})O₃, Ba(Ti_{1-y}Zr_{y})O₃, or the like, obtained by partially employing Ca, Zr, or the like, in BaTiO₃, but the present invention is not limited thereto. An average particular diameter of the ceramic powder particles may be 1.0 μm or less, but the present invention is not limited thereto.

Also, the ceramic green sheet may include a transition metal oxide or carbide, a rare earth element, magnesium (Mg), aluminum (Al), or the like, together with ceramic powder particles.

A thickness of a single dielectric layer 111 may be appropriately changed according to designing of a capacity of the MLCC. For example, a thickness of the dielectric layer 111 formed between the internal electrodes 121 and 122 after a sintering operation is performed may be 1.0 μm or less, but the present invention is not limited thereto.

The internal electrodes 121 and 122 may be formed within the ceramic element 110. The internal electrodes 121 and 122 may be formed and laminated on one dielectric layer and may be formed, while having one dielectric layer interposed therebetween, within the ceramic element 110 through a sintering operation.

The internal electrodes 121 and 122 having different polarities may be paired and may be disposed in a facing manner in a lamination direction of the dielectric layers. Ends of the first and second internal electrodes 121 and 122 may be alternately exposed from one surface of the ceramic element 110.

The thickness of the internal electrodes 121 and 122 may be appropriately determined according to an intended purpose of the MLCC, or the like. For example, the thickness of the internal electrodes 121 and 122 may be 1.0 μm or less. Alternatively, the thickness of the internal electrodes 121 and 122 may be selected from within the range of 0.1 μm to 1.0 μm.

The internal electrodes 121 and 122 may be made of a conductive paste for internal electrodes according to an embodiment of the present invention. A conductive paste composition for internal electrodes according to an embodiment of the present invention may include metal powder particles and carbon nano-tubes (CNT), and accordingly, the internal electrodes as formed may include CNTs.

The internal electrodes 121 and 122 may be formed by sintering metal powder particles, and CNTs may be disposed between and among the metal powder particles in the course of sintering the metal powder particles. The internal electrodes formed of the metal powder particles grown into grains may include CNTs. Details thereof will be described hereinafter.

The external electrodes 131 and 132 may be formed on outer surfaces of the ceramic element 110 and electrically connected to the internal electrodes 121 and 122. In detail, the external electrodes 131 and 132 include a first external electrode 131 electrically connected to the first internal electrode 121 exposed from one surface of the ceramic element 110 and a second external electrode 132 electrically connected to the second internal electrode 122 exposed from the other surface of the ceramic element 110.

Also, although not shown, the first and second internal electrodes 121 and 122 may be exposed from one or more surfaces of the ceramic element 110. Also, the first and second external electrodes 121 and 122 may be exposed from the same surface of the ceramic main body.

The external electrodes 131 and 132 may be made of a conductive paste including a conducting material. As the conductive material included in the conducting paste, for example, nickel (Ni), copper (Cu), or alloys thereof, may be used, but the present invention is not particularly limited thereto. The thickness of the external electrodes 131 and 132 may be appropriately determined according to a purpose, or the like, and it may range, for example, from about 10 μm to 50 μm.

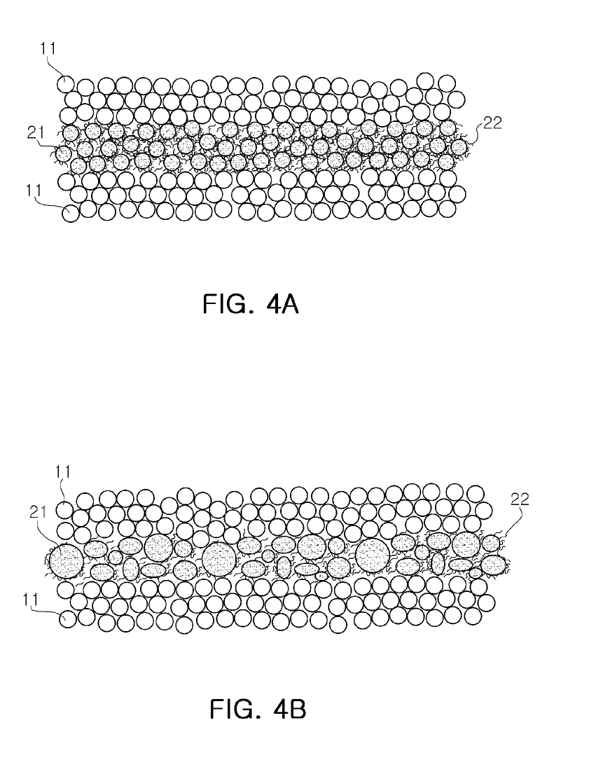

FIG. 3 is a schematic view showing a conductive paste composition for an internal electrode according to an embodiment of the present invention.

With reference to FIG. 3, a conductive paste composition for an internal electrode according to an embodiment of the present invention may include metal powder particles 21 and carbon nano-tubes (CNTs) 22.

The conductive paste composition for an internal electrode according to an embodiment of the present invention may increase adhesive strength of the dielectric layers and the internal electrode layers and reduce sintering shrinkage, minimizing a sliding effect of the internal electrode layers.

Types of the metal powder particles 21 included in the conductive paste composition are not particularly limited and a nonmetal may be used. The nonmetal may be, for example, nickel (Ni), manganese (Mn), chromium (Cr), cobalt (Co), aluminum (Al), or alloys thereof, and the metal power 21 may include one of more of them but the present invention is not limited thereto.

Also, an average particle diameter of metal powder particles 21 may be, for example, 200 nm or less, but it is not particularly limited. Preferably, the average particle diameter of metal powder particles is 180 nm or less, or ranges from 50 nm to 180 nm.

In order to form dielectric layers, ceramic green sheets may be fired at a high temperature of about 1100 L or higher so as to be fabricated. When a nonmetal such as nickel (Ni), or the like, is used as a material of the internal electrodes, the internal electrodes may be oxidized, starting from a low temperature of 400° C., and rapidly fired at 1000° C. or higher. Here, as the internal electrodes are rapidly fired, the internal electrodes may be excessively fired to be agglomerated or broken (or disconnected), resulting in a degradation of connectivity of the internal electrodes. Also, the internal structure of the MLCC may have a defect such as cracks after the firing operation.

Thus, a sintering initiation temperature of the metal powder particles 21 which start to be sintered at a relatively low temperature of about 400 L to 500 L is required to be delayed as much as possible to minimize a difference in the shrinkage with a dielectric material.

The conductive paste composition for an internal electrode according to an embodiment of the present invention may include the metal powder particles 21 and the CNTTs 22 as shown in FIG. 3.

The CNTs 22 may lower the sinter shrinkage initiation temperature of the metal powder particles 21 and restrain sintering shrinkage of the metal powder particles 21. In detail, the CNTs 22 may prevent the metal powder particles from being united to suppress a grain growth when the metal powder particles are sintered and shrunk.

The length of the CNTs 22 may be, for example, 100 nm or less, but it is not particularly limited. If the length of the CNTs 22 exceeds 100 nm, dispersibility may be degraded during the paste fabrication process and the CNTs 22 may be entangled within the paste to form a cohesion structure. For example, in case in which the particle diameter of metal powder particles ranges from tens of nanometers to hundreds of nanometers, if the length of the CNTs 22 exceeds 100 nm, the CNTs 22 may be agglomerated, rather than being adsorbed to the metal powder particles. Thus, in order to effectively disperse metal powder particles, CNTs 22 having a size of 100 nm may be added. Also, when CNTs 22 are preferentially dispersed, if the length of the CNTs 22 exceeds 100 nm, the CNTs 22 will be easily agglomerated, making it difficult to effectively disperse the CNTs 22.

The method of fabricating the CNTs 22 may not be particularly limited; the CNTs 22 may be fabricated through a known method. The CNTs 22 may be formed by applying energy overcoming Van der Waals' force to graphite to configure a SP2 carbon bond having a one-dimensional structure. The CNTs have high electric conductivity or high heat conductivity.

According to an embodiment of the present invention, the CNTs 22 may be dispersed by ultrasonic waves as tubes having a size of a few nanometers and added to the internal electrode paste.

The CNTs 22 may be mixed with a dispersing agent within a non-aqueous solvent, subjected to high shear dispersion such as ultrasonic waves, or the like, and mixed with metal powder particles to form the conductive paste for an internal electrode, but the present invention is not limited thereto.

Accordingly, as shown in FIG. 3, the metal powder particles 21 and the CNTs 222 may be uniformly dispersed in the paste.

According to an embodiment of the present invention, the content of the CNTs may be 0.1 to 10 parts by weight over 100 parts by weight of metal powder particles 100.

If the content of the CNTs is less than 0.1 parts by weight, the effect of restraining sintering shrinkage of the conductive paste for an internal electrode may be insufficient. Also, if the content of the CNTs exceeds 10 parts by weight, it may contribute toward obtaining an effect of restraining the sintering shrinkage of the metal powder particles, but carbon may remain to degrade internal reliability or other characteristics of the MLCC.

According to an embodiment of the present invention, as the CNTs 22, multi-wall (MW) CNTs, single wall (SW) CNTs, or the like, may be used.

The SWCNTs are twined to have a shape of bundles, so it is difficult to be separated into each strand and dispersed. However, according to an embodiment of the present invention, the SWCNTs can be uniformly dispersed through ultrasonic waves.

The conductive paste composition according to an embodiment of the present invention may include a dispersing agent, a binder, a solvent, or the like.

Polyvinylbutyral, cellulose-based resin, or the like, may be used as the binder. Polyvinylbutyral has strong adhesive strength, so it can enhance bonding strength of the internal electrode paste.

The cellulose-based resin has a chair type structure, having rapid recovery characteristics due to elasticity when it is deformed. Since the conductive paste composition includes a cellulose-based resin, a flat print surface can be secured.

The solvent is not particularly limited. For example, butylcarbitol, kerosene, or a terpineol-based solvent may be used as the solvent. Specific types of the terpineol-based solvent may include dehydro terpineol, dehydro terpinylacetate, and the like, but the present invention is not limited thereto.

The paste composition for an internal electrode may be printed on a ceramic green sheet, and after a lamination process is performed, the paste composition for an internal electrode may be simultaneously fired with ceramic green sheets.

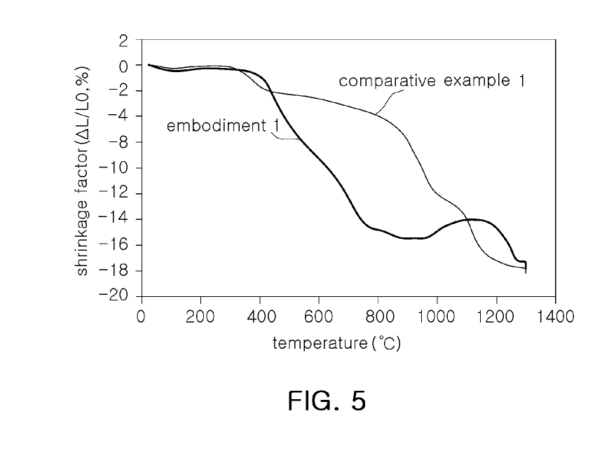

FIGS. 4A and 4B are schematic views showing a sintering shrinkage behavior of the conductive paste for an internal electrode according to an embodiment of the present invention. Specifically, FIG. 4A schematically shows an initial stage of a firing process in which the metal powder particles 21 are not sintered to be shrunk yet, and FIG. 4B schematically shows a state in which the metal powder particles 21 are being sintered to be shrunk.

With reference to FIGS. 4A and 4B, the temperature for sintering the ceramic powder particles 11 is so high that the metal powder particles 21 may proceed to be sintered to be shrunk before the ceramic powder particles 11 are sintered to be grown into grains.

According to an embodiment of the present invention, the CNTs 22 dispersed between and among the metal powder particles 21 can prevent the metal powder particles 21 from being united to be grown into grains and increase the temperature at which the metal powder particles 21 starts to be sintered to be shrunk or expand at high temperatures to enhance connectivity of the internal electrodes.

Unlike the present embodiment, in order to suppress sintering of the internal electrode paste including metal powder particles, the same ceramic base substance as the ceramic powder particles used for a dielectric layer may be added to the internal electrode paste to restrain shrinkage of the metal powder particles. Also, an additive such as yttrium (Y), dysprosium (Dy), manganese (Mg), barium (Ba), or the like, may be added together with the ceramic base substance to control a sintering shrinkage behavior of the metal powder particles.

The additive may be added in the form of Y₂O₃, Dy₂O₃, MgO (or MgCO₃), BaO (or BaCO₃) to control shrinkage of the metal powder particles such that the metal powder particles are sintered at a high temperature of 1150° C. or higher.

However, the size of the ceramic base substance powder particles may be adjusted to be different according to the size of the metal powder particles. Also, since the reliability or other characteristics of the MLCC may be changed according to the composition of the additives, it is difficult to control the composition of the additives. In addition, various additives are required to be individually dispersed and mixed according to the characteristics thereof. Thus, the increase in the number of types of additives may result in an increase in the number of processes and a degradation of dispersibility.

Recently, as the MLCCs have been reduced in size and weight and internal electrodes have become thinner, the difficulties as mentioned above have increased. The additive powder particles added to the conductive paste for an internal electrode are hard to be reduced to the nano level and the respective components are required to be dispersed, separately. Increasing the difficulty of dispersion.

In comparison, according to an embodiment of the present invention, the sintering shrinkage restraining effect of metal powder particles can be obtained by the single component of CNTs and the process can be easily conducted without having to disperse various components. Also, the CNTs can be applied equally regardless of the size of metal powder particles.

Hereinafter, a method for fabricating an MLCC according to an embodiment of the present invention will be described.

According to an embodiment of the present invention, a plurality of ceramic green sheets may be prepared. Here, in order to fabricate the ceramic green sheets, ceramic powder particles, a binder, and a solvent may be mixed to form slurry, and the slurry may be processed according to a doctor blade method into a sheet form having a thickness of a few μm. The ceramic green sheets may then be sintered to be dielectric layers forming a ceramic element.

Then, a conductive paste for an internal electrode is applied to the respective ceramic green sheets to form first and second internal electrode patterns. The first and second internal electrode patterns may be formed through a screen printing method or a Gravure printing method.

As the conductive paste for an internal electrode, the conductive paste for an internal electrode according to an embodiment of the present invention may be used, and specific components and content are as described above.

Thereafter, the plurality of ceramic green sheets are laminated and pressed in the lamination direction to compress the laminated ceramic green sheets and the internal electrode paste. Accordingly, a ceramic laminate (or a ceramic lamination body) in which the ceramic green sheets and the internal electrode paste are alternately laminated may be fabricated.

Thereafter, regions of the ceramic laminate corresponding to each capacitor are cut into chips. Here, cutting may be performed such that one end of each of the first and second internal electrode patterns is alternately exposed through a lateral surface.

Then, the ceramic laminate cut into chips is fired, thus fabricating a ceramic element.

Thereafter, first and second external electrodes may be formed to cover lateral surfaces of the ceramic element and electrically connected to the first and second internal electrodes exposed from the lateral surfaces of the ceramic element. Then, the surfaces of the external electrodes may be plated with nickel (Ni), tin (Sn), or the like.

As described above, since the sintering temperature of the ceramic green sheet is so high that the metal powder particles may be sintered to be shrunk before the ceramic powder particles may be sintered to be grown into grains. However, according to an embodiment of the present invention, the CNTs dispersed between and among the metal powder particles prevent the metal powder particles from being united to be grown into grains and increase the sintering shrinkage initiation temperature of the metal powder particles.

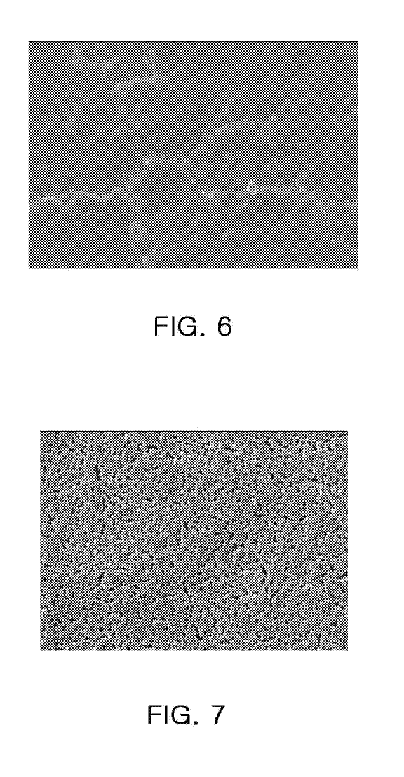

FIG. 5 is a graph showing the sintering shrinkage behavior of the conductive paste composition according to an embodiment of the present invention.

In detail, according to an embodiment 1, CNT was dispersed in a non-polar solvent through ultrasonic waves to fabricate CNT slurry, and the CNT slurry was added to a paste including nickel (Ni) powder particles. The resultant material was fired to form internal electrodes. As for the content of the CNTs, 1.5 parts by weight of CNTs were added over 100 parts by weight of nickel (Ni) powder particles.

In comparison, according to comparative example 1, 7 parts by weight of barium titanate powder particles over 100 parts by weight of nickel powder particles were added to a paste including nickel (Ni) powder particles, and then, fired to form internal electrodes.

With reference to FIG. 5, it can be seen that, the conductive paste composition of the embodiment 1 has a higher shrinkage factor at low temperatures than that of the comparative example 1 does, but it expands at high temperatures at which the dielectric layers were sintered. Thus, connectivity of the internal electrodes can be enhanced.

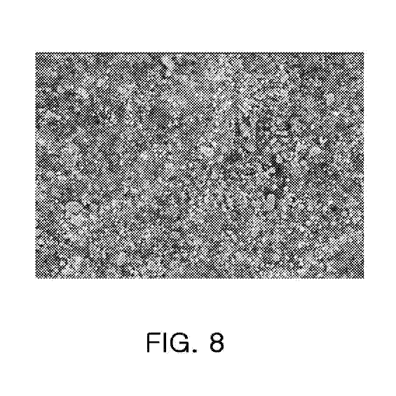

FIGS. 6 through 8 are scanning electron microscope (SEM) photographs obtained by capturing images of surfaces of internal electrodes formed according to comparative examples 2 and 3 and an embodiment 2 of the present invention, respectively.

Specifically, FIG. 6 is an SEM photograph according to a comparative example 2 in which internal electrodes were formed with a paste including nickel (Ni) powder particles without ceramic powder particles and CNTs. FIG. 7 is an SEM photograph according to a comparative example 3 in which internal electrodes were formed with a paste including nickel powder particles and 7 parts by weight of barium titanate powder particles over 100 parts by weight of the nickel powder particles. FIG. 8 is an SEM photograph according to an embodiment 2 in which internal electrodes were formed with a paste including nickel powder particles and 7 parts by weight of CNTs over 100 parts by weight of the nickel powder particles.

With reference to FIGS. 6 through 8, in the comparative example 2, metal powder particles were excessively grown into powder particles, and in the comparative example 3, grain growth of the metal powder particles were controlled by the ceramic powder particles, but still some grain growth were observed. In comparison, in the embodiment 2, it can be seen that, metal powder particles were rarely grown into grains and CNTs were present between and among metal powder particles.

As set forth above, according to embodiments of the invention, the conductive paste composition for an internal electrode can increase an adhesive strength between the dielectric layers and the internal electrode layers and reduce a firing shrinkage rate of the internal electrodes, thus minimizing a sliding effect of the internal electrode layers.

The conductive paste composition for an internal electrode can obtain a sintering shrinkage restraining effect of metal powder particles by the single component of CNTs, the process can be easily performed without having to disperse various components. Also, the CNTs can be applied equally, regardless of the size of metal powder particles.

In the conductive paste composition for an internal electrode, a sintering initiation temperature of metal powder particles is delayed as much as possible to thus minimize a difference between shrinkage factors of the metal powder particles and the dielectric substance.

The CNTs dispersed between and among metal powder particles can prevent the metal powder particles from being united to be grown into grains, increase a sintering shrinkage initiation temperature of the metal powder particles or expand at high temperatures to enhance connectivity of the internal electrodes. Also, a generation of defective internal structure of the MLCC, such as cracks, or the like, after a sintering operation can be prevented.

While the present invention has been shown and described in connection with the embodiments, it will be apparent to those skilled in the art that modifications and variations can be made without departing from the spirit and scope of the invention as defined by the appended claims.

What is claimed is:

1. A conductive paste composition for an internal electrode of a multilayer ceramic capacitor (MLCC), the composition comprising:
100 parts by weight of metal powder particles; and
0.1 to 10 parts by weight of carbon nano-tubes (CNTs).

2. The conductive paste composition of claim 1, wherein the metal power particles are formed of one or more selected from the group consisting of nickel (Ni), manganese (Mn), chromium (Cr), cobalt (Co), aluminum (Al), and alloys thereof.

3. The conductive paste composition of claim 1, wherein the length of CNTs is 100 nm or less.

4. The conductive paste composition of claim 1, wherein the CNTs are dispersed by ultrasonic waves and mixed with the metal powder particles.

5. A multilayer ceramic capacitor (MLCC) comprising:
a ceramic element; and
internal electrodes formed within the ceramic element and including carbon nano-tubes (CNTs).

6. The multilayer ceramic capacitor of claim 5, wherein the internal electrodes include 100 parts by weight of metal powder particles and 0.1 to 10 parts by weight of CNTs.

7. The multilayer ceramic capacitor of claim 6, wherein the CNTs are dispersed by ultrasonic waves and mixed with the metal powder particles.

8. The multilayer ceramic capacitor of claim 5, wherein the metal power particles are formed of one or more selected from the group consisting of nickel (Ni), manganese (Mn), chromium (Cr), cobalt (Co), aluminum (Al), and alloys thereof.

9. The multilayer ceramic capacitor of claim 5, wherein the length of CNTs is 100 nm or less.

10. The multilayer ceramic capacitor of claim 5, wherein the ceramic element and the internal electrodes are formed through simultaneous firing.
